(19) United States
(12) Patent Application Publication
(10) Pub. No.: US 2017/0184037 A1
(43) Pub. Date: Jun. 29, 2017

(54) VEHICLE

(71) Applicant: HONDA MOTOR CO., LTD., Tokyo (JP)

(72) Inventor: Mitsuo KADOTA, Wako (JP)

(73) Assignee: HONDA MOTOR CO., LTD., Tokyo (JP)

(21) Appl. No.: 15/355,067

(22) Filed: Nov. 18, 2016

(30) Foreign Application Priority Data
Dec. 24, 2015 (JP) 2015-252182

(51) Int. Cl. F02D 13/02; F02D 35/02; F02D 29/02; F02D 13/04; F02D 23/00

(52) U.S. Cl. CPC F02D 13/0249; F02D 13/04; F02D 23/00; F02D 29/02; F02D 35/02

(57) ABSTRACT

A vehicle includes a turbocharger, an exhaust-side variable valve, a vacuum servo device, an exhaust-side negative pressure hose, an exhaust-side check valve, a negative pressure supply valve, and circuitry. The exhaust-side negative pressure hose connects the vacuum servo device and a negative pressure extracting portion disposed in the exhaust passage. The exhaust-side check valve is disposed in the exhaust-side negative pressure hose to permit a gas flow only from the vacuum servo device to the exhaust passage. The negative pressure supply valve is provided in the exhaust-side negative pressure hose to open and close the exhaust-side negative pressure hose. The circuitry configured to control the exhaust-side variable valve to delay the valve timing with respect to an exhaust top dead center so as to generate negative pressure in the exhaust passage and to open the negative pressure supply valve while the negative pressure is generated in the exhaust passage.

### CROSS-REFERENCE TO RELATED APPLICATIONS

The present application claims priority under 35 U.S.C. §119 to Japanese Patent Application No. 2015-252182, filed Dec. 24, 2015, entitled “Vehicle.” The contents of this application are incorporated herein by reference in their entirety.

### BACKGROUND

Field of the Invention

The present disclosure relates to a vehicle.

Discussion of the Background

A vacuum servo device boosts an operation force of a brake pedal by a driver, that is, a wheel braking force by employing negative pressure. The vacuum servo device includes two negative pressure chambers separated by a diaphragm and is configured to introduce the atmosphere into one negative pressure chamber in response to a press on the brake pedal by the driver and thus amplify the braking force by the driver. It is necessary to maintain the inside of the diaphragm at negative pressure to use the vacuum servo device in that manner, and negative pressure generated by the aspiration of the air in the engine is typically used therefor.

However, when an engine is equipped with a turbocharger, because the pressure in an intake manifold is rarely below atmospheric pressure, an electric pump that generates negative pressure may be used to maintain the negative pressure in the vacuum servo device, as illustrated in Japanese Unexamined Patent Application Publication No. 2011-144686.

### SUMMARY

According to one aspect of the present invention, a vehicle includes a turbocharger, an exhaust-side variable valve mechanism, a vacuum servo device, an exhaust-side negative pressure hose, an exhaust-side check valve, and a negative pressure supply unit. The turbocharger is configured to pressurize intake air by employing energy of exhaust gas in an internal combustion engine. The exhaust-side variable valve mechanism is capable of changing timing of opening an exhaust valve. The vacuum servo device is configured to boost a wheel braking force by employing negative pressure. The exhaust-side negative pressure hose connects a negative pressure extracting portion disposed on an exhaust passage and the vacuum servo device. The exhaust-side check valve is disposed on the exhaust-side negative pressure hose and is configured to permit only a gas flow from the vacuum servo device side to the exhaust passage side. The negative pressure supply unit is configured to generate negative pressure in the exhaust passage by employing the exhaust-side variable valve mechanism by making the timing of opening the exhaust valve remote from an exhaust top dead center and to supply the negative pressure generated in the exhaust passage to the vacuum servo device through the exhaust-side negative pressure hose.

According to another aspect of the present invention, a vehicle includes a turbocharger, an exhaust-side variable valve, a vacuum servo device, an exhaust-side negative pressure hose, an exhaust-side check valve, a negative pressure supply valve, and circuitry. The turbocharger is driven by exhaust gas exhausted from an internal combustion engine to an exhaust passage and pressurizes intake air supplied to the internal combustion engine. The exhaust-side variable valve changes valve timing at which an exhaust valve of the internal combustion engine is opened. The vacuum servo device is operated by negative pressure to boost a wheel braking force. The exhaust-side negative pressure hose connects the vacuum servo device and a negative pressure extracting portion disposed in the exhaust passage. The exhaust-side check valve is disposed in the exhaust-side negative pressure hose to permit a gas flow only from the vacuum servo device to the exhaust passage. The negative pressure supply valve is provided in the exhaust-side negative pressure hose to open and close the exhaust-side negative pressure hose. The circuitry configured to control the exhaust-side variable valve to delay the valve timing with respect to an exhaust top dead center so as to generate negative pressure in the exhaust passage. The circuitry configured to open the negative pressure supply valve while the negative pressure is generated in the exhaust passage.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 illustrates a configuration of a vehicle according to a first embodiment of the present disclosure.

FIG. 2 illustrates changes in a cylinder internal pressure, pressure in an intake pipe, and pressure in an exhaust pipe during a normal run.

FIG. 3 illustrates changes in the cylinder internal pressure, pressure in the intake pipe, and pressure in the exhaust pipe during a deceleration fuel cutoff in the case where the timing of opening and closing an exhaust valve is retarded.

FIG. 4 illustrates a relationship between the amount of retarding the timing of opening and closing the exhaust valve and the pressure in the exhaust pipe.

FIG. 5 is a flow chart that illustrates a specific procedure of negative pressure supply control for generating negative pressure in the exhaust pipe and supplying it to a vacuum servo device while the vehicle is running.

FIG. 6 is a flow chart that illustrates a specific procedure of negative pressure supply control according to a second embodiment of the present disclosure.

FIG. 7 is a flow chart that illustrates a specific procedure of negative pressure supply control according to a third embodiment of the present disclosure.

FIG. 8 illustrates a configuration of a vehicle according to a fourth embodiment of the present disclosure.

FIG. 9 is a flow chart that illustrates a specific procedure of negative pressure supply control according to the fourth embodiment of the present disclosure.

### DESCRIPTION OF THE EMBODIMENTS

The embodiments will now be described with reference to the accompanying drawings, wherein like reference numerals designate corresponding or identical elements throughout the various drawings.

### First Embodiment

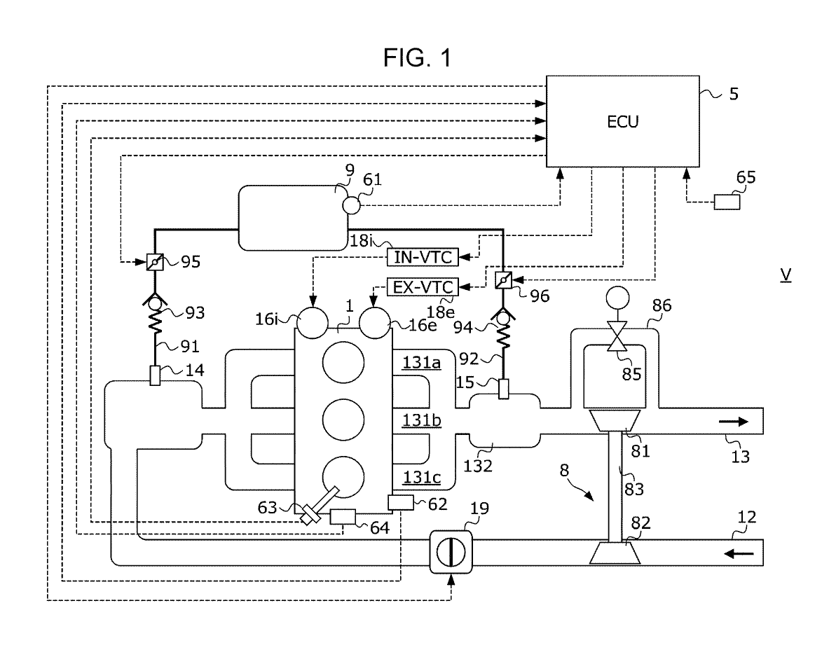

A first embodiment of the present disclosure is described below with reference to the drawings. FIG. 1 illustrates a configuration of a vehicle V according to the present embodiment. FIG. 1 illustrates in particular a configuration of an internal combustion engine (hereinafter referred to simply as “engine”) 1, which is a power source of the vehicle V, and devices disposed with the engine 1.

The engine 1 is equipped with an intake pipe 12 for guiding intake air to an intake port of the engine 1, an exhaust pipe 13 allowing exhaust gas ejected from an exhaust port of the engine 1 to flow therethrough, a throttle valve 19 for adjusting the quantity of air supplied to a combustion chamber in the engine 1, a turbocharger 8 for pressurizing the intake air by employing kinetic energy of exhaust gas, a vacuum servo device 9 for boosting a wheel braking force (not illustrated), and an electronic control unit (hereinafter abbreviated as “ECU”) 5 for controlling those components.

The engine 1 is a multi-cylinder gasoline engine, which includes two or more cylinders and uses gasoline as a fuel. The engine 1 is equipped with an intake cam shaft 16i and exhaust cam shaft 16e coupled to a crank shaft with a timing belt disposed therebetween and rotating with rotation of the crank shaft. More specifically, when the crank shaft rotates twice, the cam shafts 16i and 16e rotate once. An intake cam for opening or closing an intake valve on each cylinder is disposed on the intake cam shaft 16i. An exhaust cam for opening or closing an exhaust valve on each cylinder is disposed on the exhaust cam shaft 16e. When the cam shafts 16i and 16e rotate, the intake valve and exhaust valve advance or retard (open or close) in modes corresponding to profiles of the cams on the cam shafts 16i and 16e.

An intake-side cam phase changing mechanism (hereinafter referred to as “in-side VTC”) 18i for changing a cam phase of the intake cam with respect to the crank shaft is disposed on one end portion of the intake cam shaft 16i. An exhaust-side cam phase changing mechanism (hereinafter referred to as “ex-side VTC”) 18e for changing a cam phase of the exhaust cam with respect to the crank shaft is disposed on one end portion of the exhaust cam shaft 16e.

The in-side VTC 18i advances or delays the timing of opening and closing the intake valve (that is, intake valve open (IVO) timing and intake valve close (IVC) timing) by steplessly advancing or retarding the cam phase of the intake cam shaft 16i in response to control signals from the ECU 5. The ex-side VTC 18e advances or delays the timing of opening and closing the exhaust valve (that is, exhaust valve open (EVO) timing and exhaust valve close (EVC) timing) by steplessly advancing or retarding the cam phase of the exhaust cam shaft 16e in response to control signals from the ECU 5.

The throttle valve 19 is disposed downstream of the turbocharger 8 on the intake pipe 12. The throttle valve 19 is connected to the ECU 5 with a device driver (not illustrated) disposed therebetween. That is, the throttle valve 19 is a so-called drive-by-wire (DBW) throttle, which is not mechanically connected to an accelerator pedal (not illustrated) operated by a driver. The throttle valve 19 is adjusted to an appropriate degree of opening by intake volume control (not illustrated) performed in the ECU 5.

The turbocharger 8 includes a turbine wheel 81 on the exhaust pipe 13, a compressor wheel 82 on the intake pipe 12, and a turbine shaft 83 coupling the turbine wheel 81 and compressor wheel 82. The turbine wheel 81 is rotated by exhaust gas ejected and blown from the engine 1. The compressor wheel 82 is rotated by the turbine wheel 81, pressurizes intake air in the engine 1, and pumps it into the intake pipe 12.

A bypass conduit 86 enabling the upstream side and downstream side of the turbine wheel 81 to communicate with each other is disposed on the exhaust pipe 13. An openable/closable wastegate 85 for changing the quantity of flow of exhaust gas blown on the turbine wheel 81 is disposed on the bypass conduit 86. When the wastegate 85 is opened, the exhaust gas is ejected via the bypass conduit 86 without through the turbine wheel 81. When the wastegate 85 is closed, the exhaust gas is ejected through the turbine wheel 81 without via the bypass conduit 86. Accordingly, in the case where the engine 1 is driven in natural aspiration without actuating the turbocharger 8, the wastegate 85 is adjusted to a fully opened position. In the case where the engine 1 is driven when the turbocharger 8 is actuated and the intake air is precompressed, the wastegate 85 is adjusted between fully opened and fully closed positions.

The exhaust pipe 13 includes branch sections 131a, 131b, and 131c extending from exhaust ports in the cylinders and a collecting portion 132 in which the branch sections 131a, 131b, and 131c are joined.

The vacuum servo device 9 includes two negative-pressure chambers separated by a diaphragm. The inside of each of the negative-pressure chambers is maintained at negative pressure, which is lower than atmospheric pressure. When a driver applies a depressing force (braking force) on a brake pedal (not illustrated), the atmosphere is introduced into one negative-pressure chamber, this produces a pressure difference between the two negative-pressure chambers. The vacuum servo device 9 produces an assisting force by employing that pressure difference and boosts the braking force by the driver. As described above, the pressure in the vacuum servo device 9 is reduced every time the brake pedal is depressed. Thus, if the pressure in the vacuum servo device 9 is near the atmospheric pressure, no assisting force is produced. To produce an assisting force as the need arises, it is necessary to maintain the inside of the vacuum servo device 9 at negative pressure larger than a predetermined value.

The vacuum servo device 9 is connected to an intake-side negative pressure extracting portion 14 on the intake pipe 12 with an intake-side negative pressure hose 91 and also connected to an exhaust-side negative pressure extracting portion 15 on the exhaust pipe 13 with an exhaust-side negative pressure hose 92. An intake-side check valve 93 for permitting only a gas flow from the vacuum servo device 9 side to the intake pipe 12 side and an intake-side shutoff valve 95 for shutting off communication between the intake-side negative pressure extracting portion 14 and vacuum servo device 9 are disposed on the intake-side negative pressure hose 91. An exhaust-side check valve 94 for permitting only a gas flow from the vacuum servo device 9 side to the exhaust pipe 13 side and an exhaust-side shutoff valve 96 for shutting off communication between the exhaust-side negative pressure extracting portion 15 and vacuum servo device 9 are disposed on the exhaust-side negative pressure hose 92. In the present embodiment, the case where the exhaust-side negative pressure extracting portion 15 is disposed on the collecting portion 132, which is on an exhaust downstream side of the exhaust pipe 13, is described. The location on which the exhaust-side negative pressure extracting portion 15 is disposed is not limited to the collecting portion 132 and may be the branch sections 131a, 131b, and 131c.

When the intake-side shutoff valve 95 is opened in the situation where the inside of the intake pipe 12 is in a negative pressure state, the negative pressure in the intake pipe 12 is supplied to the vacuum servo device 9, and the pressure in the vacuum servo device 9 decreases. That is, the gas in the vacuum servo device 9 is ejected to the intake pipe 12, and the pressure in the vacuum servo device 9 decreases. When the exhaust-side shutoff valve 96 is opened in the situation where the inside of the exhaust pipe 13 is in a negative pressure state, the negative pressure in the exhaust pipe 13 is supplied to the vacuum servo device 9, and the pressure in the vacuum servo device 9 decreases. That is, the gas in the vacuum servo device 9 is ejected to the exhaust pipe 13, and the pressure in the vacuum servo device 9 decreases.

A plurality of sensors 61 to 65 for detecting states of the engine 1 and vacuum servo device 9 are disposed on the vehicle V. The negative pressure sensor 61 detects negative pressure in the vacuum servo device 9 and transmits a signal corresponding to the detected value to the ECU 5. The ECU 5 calculates a negative pressure request in the vacuum servo device 9, that is, a difference between negative pressure required to generate a sufficient assisting force in the vacuum servo device 9 and a current negative pressure by employing the detection signal from the negative pressure sensor 61.

The knock sensor 62 detects knocking occurring in the engine 1 and transmits a detection signal to the ECU 5. The cylinder internal pressure sensor 63 detects a pressure in a cylinder in the engine 1 and transmits a signal corresponding to the detected value to the ECU 5. The ECU 5 determines the presence or absence of an abnormal combustion state in the combustion chamber in the engine 1 by employing the detection signals from the knock sensor 62 and cylinder internal pressure sensor 63. Accordingly, one example of a combustion state determining unit in the present embodiment may be a combination of the ECU 5, knock sensor 62, and cylinder internal pressure sensor 63.

The crank angle sensor 64 transmits a pulse signal to the ECU 5 for each predetermined crank angle in accordance with rotation of a pulser fixed on the crank shaft. The ECU 5 grasps an actual number of revolutions of the engine on the basis of the pulse signal from the crank angle sensor 64. The accelerator pedal sensor 65 detects the amount of depression of the accelerator pedal operated by a driver and transmits a detection signal corresponding to it to the ECU 5. The load on the engine 1 is calculated by processing (not illustrated) in the ECU 5 based on the detection signal from the accelerator pedal sensor 65, the number of revolutions of the engine, and the like. Accordingly, one example of a driving state detecting unit configured to detect a driving state of the engine 1 in the present embodiment may be a combination of the ECU 5, crank angle sensor 64, and accelerator pedal sensor 65.

Next, a method for supplying negative pressure generated in the intake pipe 12 to the vacuum servo device 9 is described. The pressure in the intake pipe 12 is higher than the atmospheric pressure in a supercharging range where intake air is precompressed by the turbocharger 8 and is lower than the atmospheric pressure in a natural aspiration (NA) range where the turbocharger 8 is inactive. Accordingly, for the vehicle V including the turbocharger 8, in the case where the driving state of the engine 1 is in the NA range, the intake-side shutoff valve 95 is opened and negative pressure generated in the intake pipe 12 is supplied to the vacuum servo device 9.

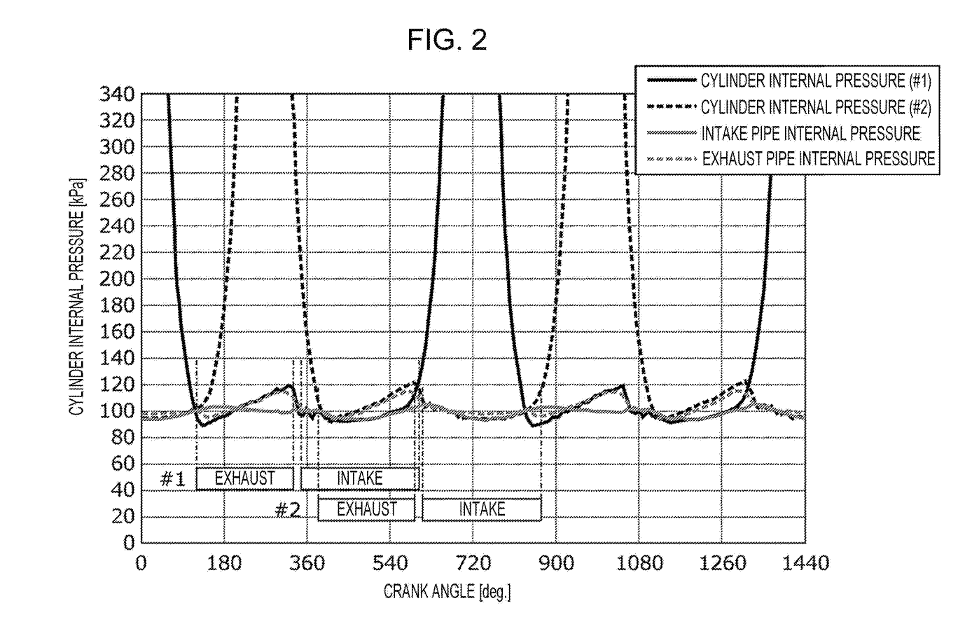

Next, a method for generating negative pressure in the exhaust pipe 13 and supplying the generated negative pressure to the vacuum servo device 9 is described with reference to FIGS. 2 to 5. FIG. 2 illustrates changes in a cylinder internal pressure in the first cylinder (thick solid line), cylinder internal pressure in the second cylinder (thick broken line), pressure in the intake pipe (light solid line), and pressure in the exhaust pipe (light broken line) during a normal run. In FIG. 2, a period for which the exhaust valve in each cylinder is opened (more specifically, a period for which the amount of lift of the exhaust valve is at or above 1 mm) and a period for which the intake valve is opened (more specifically, a period for which the amount of lift of the intake valve is at or above 1 mm) are indicated with bars.

As illustrated in FIG. 2, during a normal run, the exhaust valve is opened in the course of a power stroke and is then closed in the course of an intake stroke (more specifically, slightly after the exhaust top dead center), whereas the intake valve is opened in the course of an exhaust stroke and is then closed in the course of a compression stroke (more specifically, slightly after the bottom dead center). In that way, during a normal run, in order to improve the intake efficiency, the timing of opening and closing the exhaust valve and intake valve is set such that an overlap period for which both valves are opened is present. While the exhaust valve is opened, the exhaust pipe and the inside of the cylinder communicate with each other, and thus the cylinder internal pressure (thick solid line or thick broken line) and the pressure in the exhaust pipe (light broken line) are substantially equal. While the intake valve is opened, the intake pipe and the inside of the cylinder communicate with each other, and thus the cylinder internal pressure and the pressure in the intake pipe (light solid line) are substantially equal. As described above, during the normal run, because of the presence of an overlap period, the cylinder internal pressure and exhaust pipe internal pressure do not significantly fall below 100 kPa, which is roughly equal to the atmospheric pressure. In other words, in the case where the vehicle is in a normal run and there is an overlap period in the exhaust valve and intake valve, negative pressure having a significant magnitude is not generated in the exhaust pipe.

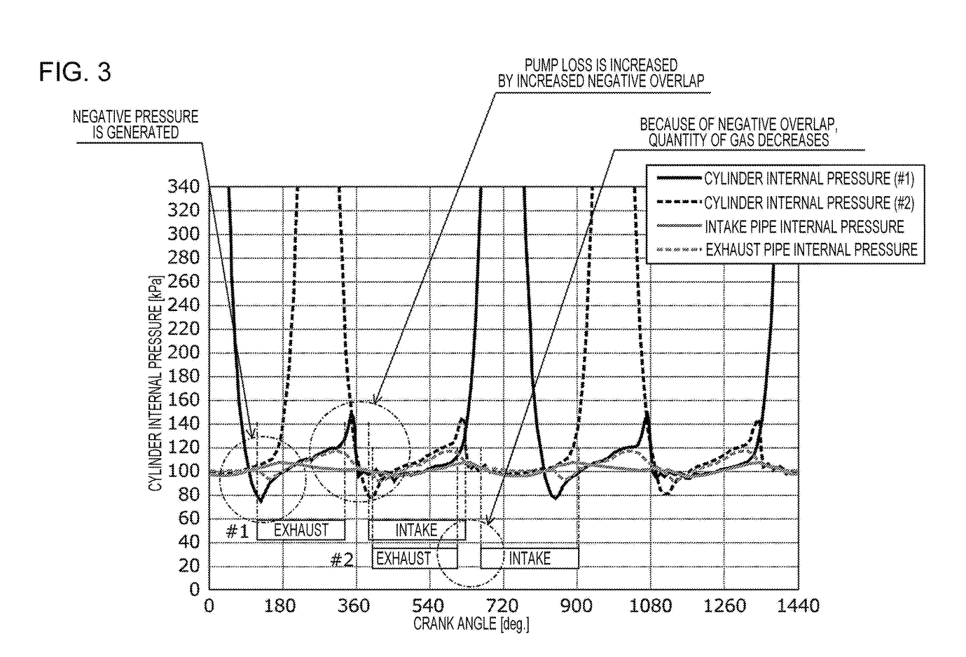

FIG. 3 illustrates changes in the cylinder internal pressure in the first cylinder (thick solid line), cylinder internal pressure in the second cylinder (thick broken line), pressure in the intake pipe being a part of an intake passage (light solid line), and pressure in the exhaust pipe being a part of an exhaust passage (light broken line) during a fuel cutoff period where fuel supply to the engine is stopped with deceleration of the vehicle. FIG. 3 illustrates the changes in the cylinder internal pressure and other pressures in the case where the timing of opening and closing the exhaust valve is retarded, in comparison with that in the normal run illustrated in FIG. 2. Here, retarding the timing of opening and closing the exhaust valve is defined in the present disclosure as being equal to making the timing of opening and closing the exhaust valve more remote from the exhaust top dead center.

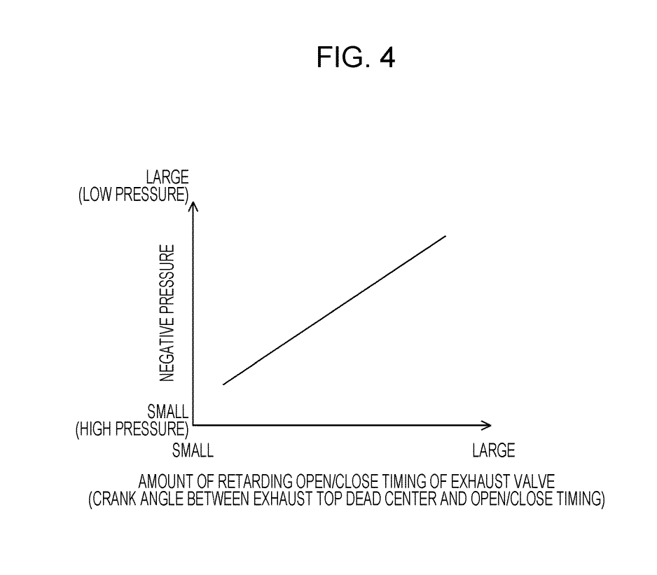

As illustrated in FIG. 3, when the timing of opening and closing the exhaust valve is retarded, because the timing of closing the exhaust valve is ahead of the timing of opening the intake valve, a negative overlap is increased. Thus, when the timing of opening and closing the exhaust valve is retarded, the quantity of gas passing through the cylinder, that is, the quantity of gas that have been introduced from the intake pipe, passed through the cylinder, and been ejected to the exhaust pipe decreases, and the pumping loss increases. As the timing of opening and closing the exhaust valve is more retarded, the gas in the cylinder more expands. Thus, as illustrated in FIG. 3, at a point in time immediately after opening the exhaust valve begins, the cylinder internal pressure and exhaust pipe internal pressure are temporarily lower than the atmospheric pressure. That is, negative pressure can be intermittently generated in the exhaust pipe by retarding the timing of opening and closing the exhaust valve in each cylinder. In that case, as illustrated in FIG. 4, the negative pressure generated in the exhaust pipe increases as the amount of retarding the timing of opening and closing the exhaust valve (that is, crank angle between the exhaust top dead center and the timing of opening and closing the exhaust valve) increases.

As described above, while the timing of opening and closing the exhaust valve is retarded, negative pressure generated in the exhaust pipe by opening the exhaust-side shutoff valve 96 illustrated in FIG. 1 and thus causing the exhaust pipe and the vacuum servo device to communicate with each other, can be supplied to the vacuum servo device. As illustration FIG. 3, the pressure in the exhaust pipe repeats negative pressure and positive pressure in an alternating manner. Accordingly, in order to reliably supply only the negative pressure to the vacuum servo device and prevent the positive pressure from being supplied thereto, preferably, the exhaust-side shutoff valve may be opened only in a period for which negative pressure is generated immediately after the exhaust valve is opened, and the exhaust-side shutoff valve may be closed in the other periods.

With reference to FIG. 3, the case where the timing of opening and closing the exhaust valve during a fuel cutoff period is retarded, in comparison with that in a normal run is described. Even while a fuel is supplied to the engine, not during a fuel cutoff period, negative pressure can be intermittently generated in the exhaust pipe by retarding the timing of opening and closing the exhaust valve, in comparison with that in the normal run.

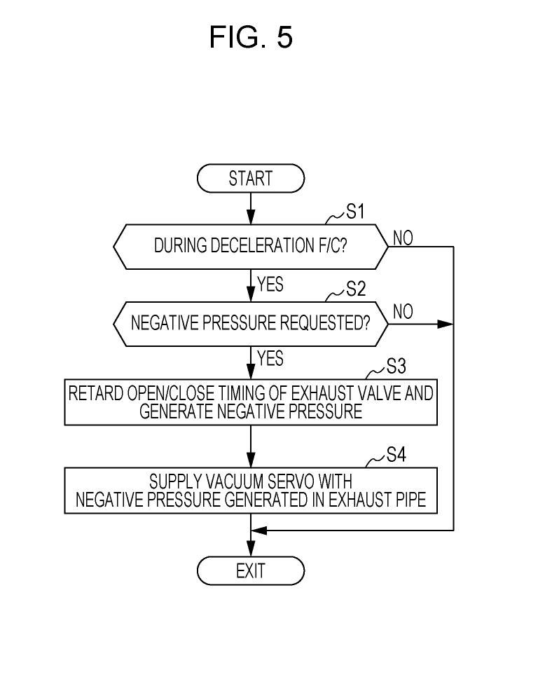

FIG. 5 is a flow chart that illustrates a specific procedure of negative pressure supply control for generating negative pressure in the exhaust pipe and supplying it to the vacuum servo device while the vehicle is running. The processing illustrated in FIG. 5 is repeated in the ECU for the period from turning on the ignition switch to turning it off, that is, at predetermined intervals while the vehicle is running.

First, at S1, the ECU determines whether the vehicle is performing a fuel cutoff associated with deceleration (that is, whether the vehicle speed is more than zero and the acceleration pedal is fully closed). When the determination at S1 is No, the processing is completed without negative pressure supply control described below. When the determination at S1 is Yes, the processing proceeds to S2.

At S2, the ECU determines by employing an output of the negative pressure sensor whether negative pressure is currently requested in the vacuum servo device. When the determination at S2 is No, the processing is completed without the negative pressure supply control described below. When the determination at S2 is Yes, the negative pressure supply control of S3 and S4 is performed.

At S3, the ECU generates negative pressure in the exhaust pipe by retarding the timing of opening and closing the exhaust valve in comparison with that in a normal run by employing the ex-side VTC, as described above with reference to FIGS. 2 and 3. As the amount of retarding the timing of opening and closing the exhaust valve increases, the negative pressure in the exhaust pipe increases, as described above with reference to FIG. 4. Accordingly, at S3, it may be preferable that as the negative pressure requested in the vacuum servo device increases, the value set as the amount of retarding the timing of opening and closing the exhaust valve increases. At S4, the ECU supplies the negative pressure generated in the exhaust pipe to the vacuum servo device by opening the exhaust-side shutoff valve with timing matching with generation of the negative pressure in the exhaust pipe, and the processing is completed. In the flow chart illustrated in FIG. 5, during a deceleration fuel cutoff, the negative pressure supply control of S3 and S4 is repeated until necessary negative pressure is supplied to the vacuum servo device.

The present embodiment can provide the advantages described below.

(1) In the present embodiment, the exhaust pipe 13 and vacuum servo device 9 are connected to each other with the exhaust-side negative pressure hose 92 equipped with the exhaust-side check valve 94, the timing of opening the exhaust valve is made remote from the exhaust top dead center, and resultant negative pressure is supplied to the vacuum servo device 9. Thus, the frequency of supplying negative pressure to the vacuum servo device 9 can be increased in the engine 1 including the turbocharger 8, which has difficulty in supplying negative pressure. Accordingly, in the present embodiment, it is not necessary to include an electric actuator for maintaining negative pressure in the vacuum servo device 9, such as a negative pressure producing pump.

When the timing of opening the exhaust valve is made remote from the exhaust top dead center, the timing of closing the exhaust valve is also made remote from the timing of opening the intake valve relatively. Accordingly, when negative pressure is generated as described above, the overlap where both the exhaust valve and intake valve are opened is reduced, the pumping loss is increased, and the quantity of gas passing through the cylinder from the intake pipe 12 side to the exhaust pipe 13 side decreases. Thus, the engine brake can be increased, deceleration of the vehicle by the brake pad can be weakened, and this results in extended life of the brake pad. When the timing of opening of the exhaust valve is made remote from the exhaust top dead center, the quantity of gas passing through the cylinder decreases, as described above, ejection of residual gas from the cylinder can be facilitated, and thus the combustion state of the engine 1 can be improved in a short time.

(2) In the present embodiment, by increasing the amount of retarding the exhaust valve as requested negative pressure increases, large negative pressure meeting the request can be generated in the exhaust pipe 13, and thus necessary negative pressure can be supplied quickly.

(3) In the present embodiment, by generating negative pressure by adjusting the timing of opening the exhaust valve during a deceleration fuel cutoff in the engine 1, the negative pressure can be generated without affecting drivability of the vehicle V and can be supplied to the vacuum servo device 9.

### Second Embodiment

Next, a second embodiment of the present disclosure is described. In the above first embodiment, the case where negative pressure is generated in the exhaust pipe during a deceleration fuel cutoff is described. The above-described method for generating negative pressure in the exhaust pipe by retarding the timing of opening and closing the exhaust valve can be executed not only during a deceleration fuel cutoff but also while fuel is supplied to the engine. In the case where the driving state of the engine is within the NA range and the throttle valve is closed, as described above, the inside of the intake pipe is in a negative pressure state. In the present embodiment, the case where negative pressure is supplied while fuel is supplied is described. In the description below, the detailed description of the same configuration as in the first embodiment is omitted.

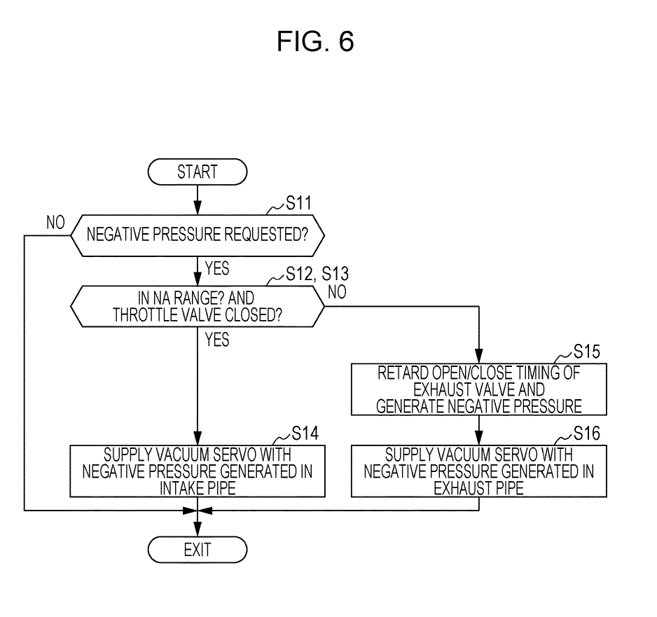

FIG. 6 is a flow chart that illustrates a specific procedure of negative pressure supply control according to the present embodiment. The processing illustrated in FIG. 6 is repeated in the ECU for the period from turning on the ignition switch to turning it off, that is, at predetermined intervals while the vehicle is running.

First, at S11, the ECU determines by employing an output of the negative pressure sensor whether negative pressure is currently requested in the vacuum servo device.

When the determination at S11 is No, the processing is completed without negative pressure supply control described below. When the determination at S11 is Yes, the negative pressure supply control of S12 to S15 is performed.

At S12, the ECU obtains the current driving state of the engine and determines whether that current driving state of the engine is within the NA range, where the turbocharger is inactive (that is, whether an engine load is in a light load range smaller than a predetermined value). At S13, the ECU determines whether the throttle valve is closed (more specifically, the degree of opening of the throttle valve is equal to or smaller than a predetermined angle near 0 degree).

When the determinations at S12 and S13 are both Yes, because negative pressure is generated in the intake pipe, as described above, the intake side is considered suitable as the source of supply of negative pressure to the vacuum servo device. Accordingly, in that case, the ECU supplies the negative pressure generated in the intake pipe to the vacuum servo by opening the intake-side shutoff valve device (see S14), and the processing is completed.

When at least one of the determinations at S12 and S13 is No, because the inside of the intake pipe is in a positive pressure state, the exhaust side is considered suitable as the source of supply of negative pressure to the vacuum servo device. Accordingly, in that case, the ECU generates negative pressure in the exhaust pipe by substantially the same way as that at S3 and S4 in FIG. 5 (see S15) and supplies the generated negative pressure to the vacuum servo device (see S16), and the processing is completed.

The present embodiment can provide the advantages described below, in addition to the above advantages (1) to (3).

(4) In the present embodiment, the exhaust pipe 13 and vacuum servo device 9 are connected to each other with the exhaust-side negative pressure hose 92, and the intake pipe 12 and vacuum servo device 9 are connected to each other with the intake-side negative pressure hose 91. Within the NA range, where negative pressure is generated in the intake pipe 12, the negative pressure generated in the intake pipe 12 is supplied to the vacuum servo device 9. Thus, because the negative pressure can be supplied to the vacuum servo device 9 from both the intake pipe 12 and exhaust pipe 13, the frequency of supplying negative pressure can be further increased.

(5) In the present embodiment, negative pressure supply source switching control for switching the source of supply of negative pressure to the vacuum servo device 9 between the exhaust side and intake side is performed in accordance with the driving state of the engine 1 and the magnitude of the negative pressure in the vacuum servo device 9. Thus, the negative pressure can be supplied to the vacuum servo device 9 with appropriate timing matching with the pressures in the exhaust pipe 13 and intake pipe 12.

### Third Embodiment

Next, a third embodiment of the present disclosure is described. As described above with reference to FIGS. 2 and 3, when negative pressure is generated by retarding the timing of opening and closing the exhaust valve, because the quantity of gas passing through the cylinder decreases, the advantage of facilitating ejection of gas so far remaining in the cylinder is achieved. In the present embodiment, the case where the advantage of ejecting residual gas achieved by generation of negative pressure in the exhaust pipe is actively used is described. In the description below, the detailed description of the same configuration as in the first embodiment is omitted.

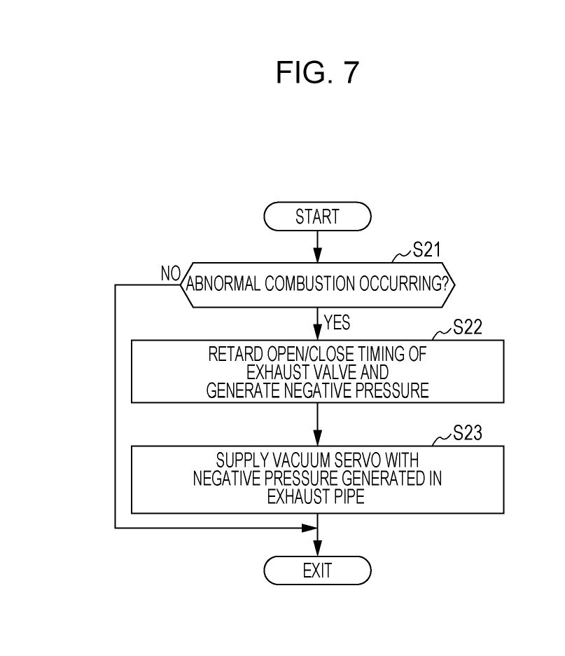

FIG. 7 is a flow chart that illustrates a specific procedure of negative pressure supply control according to the present embodiment. The processing illustrated in FIG. 7 is repeated in the ECU for the period from turning on the ignition switch to turning it off, that is, at predetermined intervals while the vehicle is running.

At S21, the ECU determines by employing outputs of the knock sensor and cylinder internal pressure sensor whether abnormal combustion is occurring. When the determination at S21 is No, the processing is completed without negative pressure supply control described below. When the determination at S21 is Yes, the ECU generates negative pressure in the exhaust pipe in substantially the same way as that at S3 and S4 in FIG. 5 (see S22) and supplies the generated negative pressure to the vacuum servo device (see S23), and the processing is completed.

The present embodiment can provide the advantage described below, in addition to the above advantages (1) to (5).

(6) In the present embodiment, when it is determined that the combustion state of the engine 1 is abnormal, the timing of opening the exhaust valve is retarded, and negative pressure is generated in the exhaust pipe 13. By the generation of negative pressure with that timing, the ejection of residual gas from the cylinder can be facilitated, this enables the combustion state to quickly return to a good state, and the generated negative pressure can be supplied to the vacuum servo device 9.

### Fourth Embodiment

Next, a fourth embodiment of the present disclosure is described. In the above first to third embodiments, the cases where the destination of supply of negative pressure generated in the exhaust pipe or intake pipe is the vacuum servo device are described. The destination of supply of negative pressure is not limited to the vacuum servo device. The vehicle is equipped with various devices. In the present embodiment, the case where the vehicle further includes a negative pressure utilization device activated by employing negative pressure, in addition to the vacuum servo device, is described. In the description below, the detailed description of the same configuration as in the first embodiment is omitted.

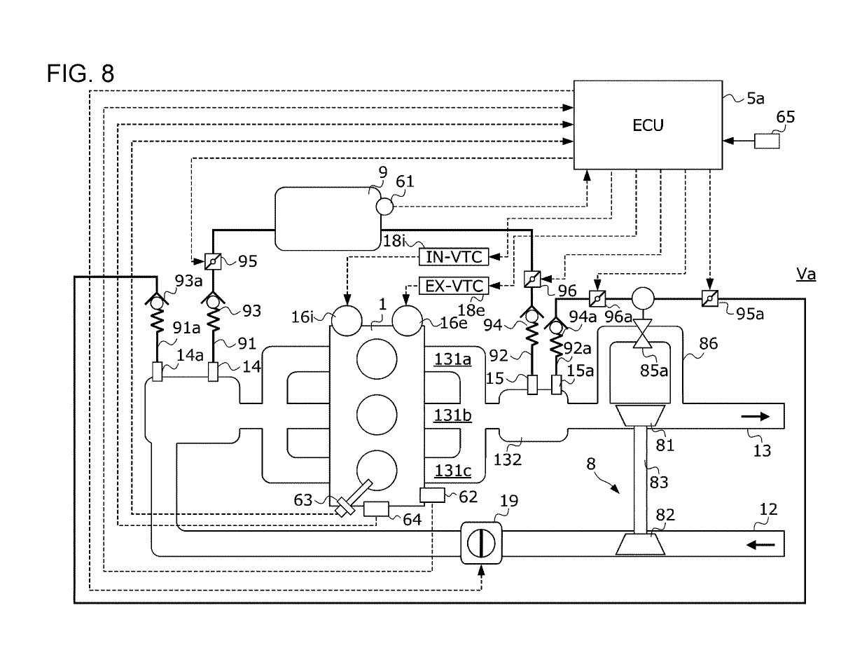

FIG. 8 illustrates a configuration of a vehicle Va according to the present embodiment. In the present embodiment, a negative pressure-activated wastegate 85a configured to change its degree of opening in accordance with the magnitude of supplied negative pressure is used as the negative pressure utilization device.

The wastegate 85a is connected to an intake-side negative pressure extracting portion 14a on the intake pipe 12 with an intake-side negative pressure hose 91a and also connected to an exhaust-side negative pressure extracting portion 15a on the exhaust pipe 13 with an exhaust-side negative pressure hose 92a. An intake-side check valve 93a for permitting only a gas flow from the wastegate 85a side to the intake pipe 12 side and an intake-side shutoff valve 95a for shutting off communication between the intake-side negative pressure extracting portion 14a and wastegate 85a are disposed on the intake-side negative pressure hose 91a. An exhaust-side check valve 94a for permitting only a gas flow from the wastegate 85a side to the exhaust pipe 13 side and an exhaust-side shutoff valve 96a for shutting off communication between the exhaust-side negative pressure extracting portion 15a and wastegate 85a are disposed on the exhaust-side negative pressure hose 92a.

When the intake-side shutoff valve 95a is opened in the situation where the inside of the intake pipe 12 is in a negative pressure state, the negative pressure in the intake pipe 12 is supplied to the wastegate 85a, and in response to this, the degree of opening of the wastegate 85a changes. When the exhaust-side shutoff valve 96a is opened in the situation where the inside of the exhaust pipe 13 is in a negative pressure state, the negative pressure in the exhaust pipe 13 is supplied to the wastegate 85a, and in response to this, the degree of opening of the wastegate 85a changes.

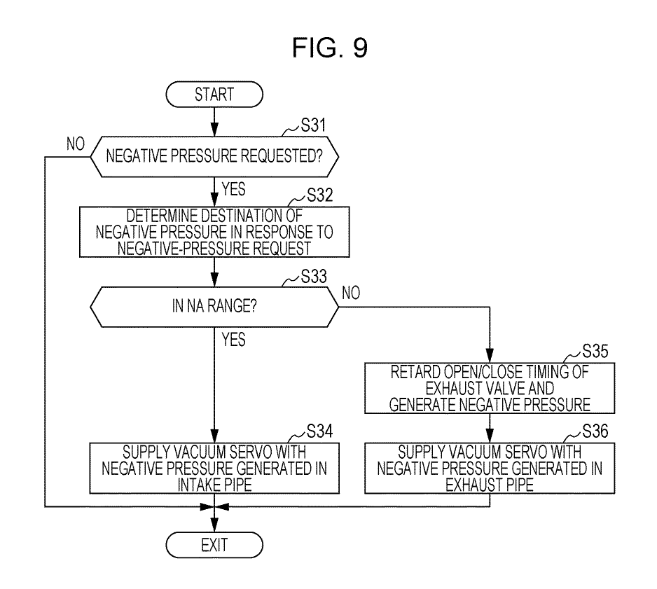

FIG. 9 is a flow chart that illustrates a specific procedure of negative pressure supply control according to the present embodiment. The processing illustrated in FIG. 9 is repeated in an ECU 5a for the period from turning on the ignition switch to turning it off, that is, at predetermined intervals while the vehicle is running.

At S31, the ECU determines whether negative pressure is requested in at least one of the wastegate and vacuum servo device, both of which can be a destination of supply of negative pressure. When the determination at S31 is No, the processing is completed without negative pressure supply control described below. When the determination at S31 is Yes, the processing proceeds to S32.

At S32, the ECU determines the destination of supply of negative pressure in response to the request for negative pressure from the wastegate and/or vacuum servo device. Here, in the case where the negative pressure is requested in both of the two devices at the same time, preferably, it may be determined that the destination of supply of negative pressure is a device that requests larger negative pressure. At S33 to S36, the ECU supplies the destination of supply of negative pressure determined at S32 with negative pressure generated in the intake pipe or exhaust pipe by substantially the same procedure as that at S12 to S15 in FIG. 7. In the flow chart in FIG. 9, the destination of supply of negative pressure can switch between the vacuum servo device and wastegate in accordance with a request for negative pressure from the vacuum servo device and/or wastegate.

In the above embodiment, the case where the negative pressure-activated wastegate 85a is used as the negative pressure utilization device is described. The number of negative pressure utilization devices is not limited to one, and a plurality of negative pressure utilization devices may also be used. Examples of the negative pressure utilization devices may include, in addition to the wastegate 85a, an air bypass valve and blow-by circuit.

The present embodiment can provide the advantages described below, in addition to the above advantages (1) to (6).

(7) In the present embodiment, the supply destination switching control for switching the destination of supply of negative pressure generated in the exhaust pipe 13 between the vacuum servo device 9 and wastegate 85a is performed in response to a request for negative pressure from the vacuum servo device 9 and/or a request for negative pressure from the wastegate 85a. Thus, negative pressure with appropriate magnitude can be supplied to a device that requires the negative pressure.

The present disclosure is not limited to the above-described four embodiments. For example, in the first embodiment, the case where the exhaust-side negative pressure extracting portion 15 is disposed on only one branch section 131b in the exhaust pipe 13 is described. The position of the exhaust-side negative pressure extracting portion 15 and the number thereof are not limited to the above examples. One exhaust-side negative pressure extracting portion may be disposed on each of the branch sections 131a, 131b, and 131c, which extend from the cylinders in the engine 1, respectively. In that case, each of the three exhaust-side negative pressure extracting portions on the branch sections 131a, 131b, and 131c is connected to the vacuum servo device 9 with the corresponding exhaust-side negative pressure hose equipped with the exhaust-side check valve and exhaust-side shutoff valve disposed therebetween. In the case where the cylinders are connected to the vacuum servo device 9 with their respective exhaust-side negative pressure hoses, the ECU 5 obtains the magnitude of negative pressure requested in the vacuum servo device, selects the cylinder to which the negative pressure is to be supplied in accordance with the magnitude of requested negative pressure, opens and closes the exhaust-side shutoff valve corresponding to the selected cylinder, and thus supplies the negative pressure generated in the branch section communicating with each of the cylinders. As described above with reference to FIGS. 2 and 3, when the timing of opening and closing the exhaust valve is retarded, negative pressure is generated with timing varying among cylinders. Accordingly, by increasing the number of selected cylinders as the requested negative pressure increases, the requested negative pressure can be quickly supplied to the vacuum servo device.

In the above-described embodiments, the cases where the present disclosure is applied to a multi-cylinder engine, which includes two or more cylinders, are described. The present disclosure is not limited to the above cases. The present disclosure may also be applied to a single-cylinder engine.

(1) A vehicle includes a turbocharger configured to pressurize intake air by employing energy of exhaust gas in an internal combustion engine, an exhaust-side variable valve mechanism capable of changing timing of opening an exhaust valve, a vacuum servo device configured to boost a wheel braking force by employing negative pressure, an exhaust-side negative pressure hose that connects a negative pressure extracting portion disposed on an exhaust passage and the vacuum servo device, an exhaust-side check valve disposed on the exhaust-side negative pressure hose and configured to permit only a gas flow from the vacuum servo device side to the exhaust passage side, and a negative pressure supply unit configured to generate negative pressure in the exhaust passage by employing the exhaust-side variable valve mechanism by making the timing of opening the exhaust valve remote from an exhaust top dead center and to supply the negative pressure generated in the exhaust passage to the vacuum servo device through the exhaust-side negative pressure hose.

(1) When the timing of opening the exhaust valve is made remote from the exhaust top dead center, the gas in the cylinder is expanded, and the inside of the exhaust passage becomes a negative pressure state. In the present disclosure, the exhaust passage and vacuum servo device are connected to each other with the exhaust-side negative pressure hose equipped with the exhaust-side check valve, the timing of opening the exhaust valve is made remote from the exhaust top dead center by employing the exhaust-side variable valve mechanism, and the resultant negative pressure is supplied to the vacuum servo device. Thus, in the internal combustion engine including the turbocharger, which has difficulty in reducing the pressure in the intake passage and supplying the negative pressure, the frequency of supplying negative pressure to the vacuum servo device can be increased. Accordingly, in the present disclosure, it is not necessary to include an electric actuator for maintaining the negative pressure in the vacuum servo device, such as a negative pressure producing pump.

When the timing of opening the exhaust valve is made remote from the exhaust top dead center, the timing of closing the exhaust valve also becomes remote from the timing of opening the intake valve relatively. Accordingly, when the negative pressure is generated by employing the exhaust-side variable valve mechanism, as described above, an overlap where both the exhaust valve and intake valve are opened is reduced, the pumping loss is increased, and the quantity of gas passing through the cylinder from the intake passage side to the exhaust passage side decreases. Thus, the engine brake can be increased, deceleration of the vehicle by the brake pad can be weakened, and this results in extended life of the brake pad. When the timing of opening of the exhaust valve is made remote from the exhaust top dead center, the quantity of gas passing through the cylinder decreases, as described above, ejection of residual gas from the cylinder can be facilitated, and thus the combustion state of the internal combustion engine can be improved in a short time.

(2) The vehicle may preferably further include an intake-side negative pressure hose configured to allow an negative pressure extracting portion disposed on an intake passage and the vacuum servo device to communicate with each other and an intake-side check valve disposed on the intake-side negative pressure hose and configured to permit a gas flow from the vacuum servo device side to the intake passage side. The negative pressure supply unit may preferably be configured to supply the negative pressure generated in the intake passage to the vacuum servo device through the intake-side negative pressure hose in a driving range where the negative pressure is generated in the intake passage.

(2) In the present disclosure, as described above, the exhaust passage and the vacuum servo device are connected to each other with the exhaust-side negative pressure hose equipped with the check valve, and the intake passage and the vacuum servo device are connected to each other with the intake-side negative pressure hose equipped with the check valve. In the driving range where the negative pressure is generated in the intake passage, the negative pressure generated in the intake passage is supplied to the vacuum servo device. Thus, the negative pressure can be supplied to the vacuum servo device from both the intake passage and exhaust passage, and the frequency of supplying the negative pressure can be further increased.

(3) The vehicle may preferably further include a negative pressure sensor configured to detect pressure in the vacuum servo device and a driving state detecting unit configured to detect a driving state of the internal combustion engine. The negative pressure supply unit may preferably be configured to switch between supplying the vacuum servo device with the negative pressure generated in the exhaust passage and supplying the vacuum servo device with the negative pressure generated in the intake passage by employing the pressure in the vacuum servo device detected by the negative pressure sensor the driving state of the internal combustion engine.

(3) In the present disclosure, negative pressure supply source switching control for switching the source of supply of negative pressure to the vacuum servo device between the exhaust passage and intake passage is performed in accordance with the driving state of the internal combustion engine and the magnitude of the negative pressure in the vacuum servo device. Thus, the negative pressure can be supplied to the vacuum servo device with appropriate timing matching with the pressures in the exhaust passage and intake passage.

(4) The vehicle may preferably further include a negative pressure utilization device different from the vacuum servo device and configured to be activated by employing negative pressure. The negative pressure utilization device is connected to the exhaust passage with a negative pressure hose. The negative pressure supply unit may preferably be configured to switch a destination of supply of the negative pressure generated in the exhaust passage between the vacuum servo device and the negative pressure utilization device in response to a request for negative pressure from the vacuum servo device and/or a request for negative pressure from the negative pressure utilization device.

(4) In the present disclosure, supply destination switching control for switching the destination of supply of negative pressure generated in the exhaust passage between the vacuum servo device and negative pressure utilization device is performed in response to a request for negative pressure from the vacuum servo device and/or a request for negative pressure from the negative pressure utilization device. Thus, negative pressure with appropriate magnitude can be supplied to a device that requires the negative pressure.

(5) The negative pressure supply unit may preferably be configured to increase a crank angle between the exhaust top dead center and the timing of opening the exhaust valve as magnitude of the negative pressure in the request increases.

(5) When the crank angle between the exhaust top dead center and the timing of opening the exhaust valve is increased, the negative pressure generated in the exhaust passage is increased. In the present disclosure, by increasing the above crank angle as the magnitude of the negative pressure in the request increases, that is, the requested negative pressure becomes larger, large negative pressure meeting the request can be generated in the exhaust passage, and thus the necessary negative pressure can be quickly supplied.

(6) The internal combustion engine may preferably include a plurality of cylinders, the negative pressure extracting portion on the exhaust passage may preferably include a plurality of negative pressure extracting portions disposed on branch sections extending from the cylinders, respectively, the exhaust-side negative pressure hose may preferably include a plurality of pipes connecting the negative pressure extracting portions on the branch sections and the vacuum servo device, each of the pipes may preferably be equipped with a shutoff valve configured to shut off communication between the negative pressure extracting portion on the cylinder and the vacuum servo device, and the negative pressure supply unit may preferably be configured to receive the request for negative pressure from the vacuum servo device, open and close each of the shutoff valves to meet the request for negative pressure, and supply the negative pressure generated in the exhaust passage to the vacuum servo device.

(6) When the timing of opening the exhaust valve remote from the exhaust top dead center, as described above, negative pressure is periodically generated in the exhaust passage for each cylinder. In the present disclosure, the vacuum servo device and the negative pressure extracting portions disposed on the plurality of cylinders, respectively, are connected to each other with the plurality of pipes, and the shutoff valves for shutting off communication between the vacuum servo device and cylinders are disposed on the pipes. In the present disclosure, supply source selecting control for selecting opening or closing of these shutoff valves, that is, selecting the source of supply of negative pressure to the vacuum servo device in response to the request for negative pressure from the vacuum servo device to meet that request for negative pressure. Thus, the negative pressure having magnitude required in the vacuum servo device can be quickly supplied.

(7) The negative pressure supply unit may preferably be configured to generate the negative pressure in the exhaust passage by making the timing of opening the exhaust valve remote from the exhaust top dead center during a fuel cutoff at which fuel supply to the internal combustion engine is stopped.

(7) In the present disclosure, the generation of negative pressure by adjusting the timing of opening the exhaust valve during the fuel cutoff in the internal combustion engine enables the generation of negative pressure and supplying it to the vacuum servo device without affecting the drivability of the vehicle.

(8) The vehicle may preferably further include a combustion state determining unit configured to determine presence or absence of an abnormal combustion state in a combustion chamber in the internal combustion engine. The negative pressure supply unit may preferably be configured to generate the negative pressure in the exhaust passage by making the timing of opening the exhaust valve remote from the exhaust top dead center when it is determined that the abnormal combustion state is present while the internal combustion engine is driven.

(8) In the present disclosure, when it is determined that the combustion state of the internal combustion engine is abnormal, the negative pressure is generated in the exhaust passage by making the timing of opening the exhaust valve remote from the exhaust top dead center. By the generation of the negative pressure with such timing, the ejection of residual gas from the cylinder can be facilitated, this enables the combustion state to quickly return to a good state, and the generated negative pressure can be supplied to the vacuum servo device.

Obviously, numerous modifications and variations of the present invention are possible in light of the above teachings. It is therefore to be understood that within the scope of the appended claims, the invention may be practiced otherwise than as specifically described herein.

What is claimed is:

1. A vehicle comprising:
a turbocharger configured to pressurize intake air by employing energy of exhaust gas in an internal combustion engine;
an exhaust-side variable valve mechanism capable of changing timing of opening an exhaust valve;
a vacuum servo device configured to boost a wheel braking force by employing negative pressure;
an exhaust-side negative pressure hose that connects a negative pressure extracting portion disposed on an exhaust passage and the vacuum servo device;
an exhaust-side check valve disposed on the exhaust-side negative pressure hose and configured to permit only a gas flow from the vacuum servo device side to the exhaust passage side; and
a negative pressure supply unit configured to generate negative pressure in the exhaust passage by employing the exhaust-side variable valve mechanism by making the timing of opening the exhaust valve remote from an exhaust top dead center and to supply the negative pressure generated in the exhaust passage to the vacuum servo device through the exhaust-side negative pressure hose.

2. The vehicle according to claim 1, further comprising:
an intake-side negative pressure hose configured to allow a negative pressure extracting portion disposed on an intake passage and the vacuum servo device to communicate with each other; and
an intake-side check valve disposed on the intake-side negative pressure hose and configured to permit a gas flow from the vacuum servo device side to the intake passage side,
wherein the negative pressure supply unit is configured to supply the negative pressure generated in the intake passage to the vacuum servo device through the intake-side negative pressure hose in a driving range where the negative pressure is generated in the intake passage.

3. The vehicle according to claim 2, further comprising:
a negative pressure sensor configured to detect pressure in the vacuum servo device; and
a driving state detecting unit configured to detect a driving state of the internal combustion engine,
wherein the negative pressure supply unit is configured to switch between supplying the vacuum servo device with the negative pressure generated in the exhaust passage and supplying the vacuum servo device with the negative pressure generated in the intake passage by employing the pressure in the vacuum servo device detected by the negative pressure sensor the driving state of the internal combustion engine.

4. The vehicle according to claim 1, further comprising:
a negative pressure utilization device different from the vacuum servo device and configured to be activated by employing negative pressure,
wherein the negative pressure utilization device is connected to the exhaust passage with a negative pressure hose, and
the negative pressure supply unit is configured to switch a destination of supply of the negative pressure generated in the exhaust passage between the vacuum servo device and the negative pressure utilization device in response to a request for negative pressure from the vacuum servo device and/or a request for negative pressure from the negative pressure utilization device.

5. The vehicle according to claim 4, wherein the negative pressure supply unit is configured to increase a crank angle between the exhaust top dead center and the timing of opening the exhaust valve as magnitude of the negative pressure in the request increases.

6. The vehicle according to claim 1, wherein the internal combustion engine includes a plurality of cylinders,
the negative pressure extracting portion on the exhaust passage includes a plurality of negative pressure extracting portions disposed on branch sections extending from the cylinders, respectively,
the exhaust-side negative pressure hose includes a plurality of pipes connecting the negative pressure extracting portions on the branch sections and the vacuum servo device,
each of the pipes is equipped with a shutoff valve configured to shut off communication between the negative pressure extracting portion on the cylinder and the vacuum servo device, and
the negative pressure supply unit is configured to receive the request for negative pressure from the vacuum servo device, open and close each of the shutoff valves to meet the request for negative pressure, and supply the negative pressure generated in the exhaust passage to the vacuum servo device.

7. The vehicle according to claim 1, wherein the negative pressure supply unit is configured to generate the negative pressure in the exhaust passage by making the timing of opening the exhaust valve remote from the exhaust top dead center during a fuel cutoff at which fuel supply to the internal combustion engine is stopped.

8. The vehicle according to claim 1, further comprising a combustion state determining unit configured to determine presence or absence of an abnormal combustion state in a combustion chamber in the internal combustion engine,
wherein the negative pressure supply unit is configured to generate the negative pressure in the exhaust passage by making the timing of opening the exhaust valve remote from the exhaust top dead center when it is determined that the abnormal combustion state is present while the internal combustion engine is driven.

9. A vehicle comprising:
a turbocharger to be driven by exhaust gas exhausted from an internal combustion engine to an exhaust passage and to pressurize intake air supplied to the internal combustion engine;
an exhaust-side variable valve to change valve timing at which an exhaust valve of the internal combustion engine is opened;
a vacuum servo device to be operated by negative pressure to boost a wheel braking force;
an exhaust-side negative pressure hose connecting the vacuum servo device and a negative pressure extracting portion disposed in the exhaust passage;
an exhaust-side check valve disposed in the exhaust-side negative pressure hose to permit a gas flow only from the vacuum servo device to the exhaust passage;
a negative pressure supply valve provided in the exhaust-side negative pressure hose to open and close the exhaust-side negative pressure hose; and
circuitry configured to
control the exhaust-side variable valve to delay the valve timing with respect to an exhaust top dead center so as to generate negative pressure in the exhaust passage; and
open the negative pressure supply valve while the negative pressure is generated in the exhaust passage.

10. The vehicle according to claim 9, further comprising:
an intake-side negative pressure hose configured to allow the negative pressure extracting portion disposed on an intake passage and the vacuum servo device to communicate with each other; and
an intake-side check valve disposed on the intake-side negative pressure hose and configured to permit a gas flow from the vacuum servo device to the intake passage,
wherein the negative pressure supply valve is configured to supply the negative pressure generated in the intake passage to the vacuum servo device through the intake-side negative pressure hose in a driving range where the negative pressure is generated in the intake passage.

11. The vehicle according to claim 10, further comprising:
a negative pressure sensor configured to detect pressure in the vacuum servo device; and
a driving state detecting unit configured to detect a driving state of the internal combustion engine,
wherein the negative pressure supply valve is configured to switch between supplying the vacuum servo device with the negative pressure generated in the exhaust passage and supplying the vacuum servo device with the negative pressure generated in the intake passage by employing the pressure in the vacuum servo device detected by the negative pressure sensor the driving state of the internal combustion engine.

12. The vehicle according to claim 9, further comprising:
a negative pressure utilization device different from the vacuum servo device and configured to be activated by employing negative pressure,
wherein the negative pressure utilization device is connected to the exhaust passage with a negative pressure hose, and
the negative pressure supply valve is configured to switch a destination of supply of the negative pressure generated in the exhaust passage between the vacuum servo device and the negative pressure utilization device in response to a request for negative pressure from the vacuum servo device and/or a request for negative pressure from the negative pressure utilization device.

13. The vehicle according to claim 12, wherein the negative pressure supply valve is configured to increase a crank angle between the exhaust top dead center and the timing of opening the exhaust valve as magnitude of the negative pressure in the request increases.

14. The vehicle according to claim 9, wherein the internal combustion engine includes a plurality of cylinders,
the negative pressure extracting portion on the exhaust passage includes a plurality of negative pressure extracting portions disposed on branch sections extending from the cylinders, respectively,
the exhaust-side negative pressure hose includes a plurality of pipes connecting the negative pressure extracting portions on the branch sections and the vacuum servo device,
each of the pipes is equipped with a shutoff valve configured to shut off communication between the negative pressure extracting portion on the cylinder and the vacuum servo device, and
the negative pressure supply valve is configured to receive the request for negative pressure from the vacuum servo device, open and close each of the shutoff valves to meet the request for negative pressure, and supply the negative pressure generated in the exhaust passage to the vacuum servo device.

15. The vehicle according to claim 9, wherein the negative pressure supply valve is configured to generate the negative pressure in the exhaust passage by making the timing of opening the exhaust valve remote from the exhaust top dead center during a fuel cutoff at which fuel supply to the internal combustion engine is stopped.

16. The vehicle according to claim 9, further comprising a combustion state determining unit configured to determine presence or absence of an abnormal combustion state in a combustion chamber in the internal combustion engine,
wherein the negative pressure supply valve is configured to generate the negative pressure in the exhaust passage by making the timing of opening the exhaust valve remote from the exhaust top dead center when it is determined that the abnormal combustion state is present while the internal combustion engine is driven.
